(19) United States
(12) Patent Application Publication
(10) Pub. No.: US 2019/0142039 A1
(43) Pub. Date: May 16, 2019

(54) METHOD FOR PRODUCING UNFRIED NUGGET-LIKE PRODUCTS

(71) Applicant: ROQUETTE FRERES, Lestrem (FR)

(72) Inventors: Edith DUBAL, Richebourg (FR); Géraldine DEDIEU, Loos (FR)

(21) Appl. No.: 16/095,231

(22) PCT Filed: Apr. 4, 2017
(86) PCT No.: PCT/FR2017/050793

§ 371 Date: Oct. 19, 2018

(30) Foreign Application Priority Data
Apr. 28, 2016 (FR) 1653805

(51) Int. Cl. A23L 13/50; A23L 3/36; A23P 20/12; A23L 29/269; A23L 29/212; A23L 5/10

(52) U.S. Cl. CPC A23L 13/57; A23L 3/36; A23L 5/13; A23L 29/273; A23L 29/212; A23P 20/12

(57) ABSTRACT

The present invention concerns a method for producing unfried breaded nugget-like products, comprising a step of preparing a particular coating paste, in particular from rice flour and modified starches, combined with a step of cooking in a steam oven. This method can be used in order to obtain nugget-like products that have the required crispness, uniformity and colour characteristics and a reduced fat content. The invention also concerns a nugget-like product likely to be obtained using the abovementioned method.

### TECHNICAL FIELD OF THE INVENTION

The present invention relates to a process for producing products coated in breadcrumbs of the unfried nugget type, comprising a step of preparing a particular batter, especially from rice flour and modified starches, combined with a step of cooking in a steam oven.

This process makes it possible to obtain nuggets having the required characteristics of crispiness, uniformity, color, and reduced fat content.

The invention also relates to the nugget able to be obtained according to the abovementioned process.

### CONTEXT OF THE INVENTION

Health and nutrition are increasingly important issues for consumers and are at the heart of industrial innovations.

In the field of culinary preparations, fried products, especially products coated in breadcrumbs, such as escalopes coated in breadcrumbs, chicken coated in breadcrumbs stuffed with ham and cheese, chicken bites coated in breadcrumbs (referred to as chicken “nuggets”), or fish coated in breadcrumbs, are generally well liked by consumers. The breadcrumb coating not only provides crispiness, but also an attractive appearance for the consumer. Products coated in breadcrumbs are also well liked by consumers and restaurant owners, especially in institutional catering, due to the fact that they can be provided in a ready to use state, then only requiring appropriate reheating.

However, the nutritional values of products coated in breadcrumbs do not generally correspond to the requirements of a balanced diet, especially due to their high fat content and their low protein/lipid weight ratio. Moreover, frying processes have a very bad press for consumers.

According to international patent application WO 2008/107585, unfried meat-based products of the type coated in breadcrumbs exist on the market. However, the coating on these products does not have the crispiness-melt in the mouth nature of traditional products coated in breadcrumbs, and they also have a hard and dry mouthfeel. These products are therefore unsatisfactory from an organoleptic perspective.

Thus, it is suggested in this patent application that, in order to reduce the amount of fat in products coated in breadcrumbs such as nuggets, three solutions are available to producers:

modifying the quality of the matrix (reducing the incorporation of fats and mainly using high quality parts).

changing the properties of the coating (creating “barriers” against the entry of oil).

modifying the manufacturing process (alternatives to frying).

Conventionally, the steps of frying in the process of producing products coated in breadcrumbs provide sensory characteristics specific to these products but also increase their fat content.

As an alternative to frying, manufacturers have therefore adapted to the market by offering for example pre-fried products that may be cooked in the oven at the consumer's home. Removing the step of frying at the consumer's home thus reduces the percentage of fat ingested.

A certain number of alternative solutions to frying have thus been proposed:

in patent application FR 2911046, a glazing step has been proposed in the manufacturing process in order to protect the coated product from ambient humidity and to set it. It has also been proposed to incorporate oil into the batter rather than by frying in order to more readily manage the supply of fats.

In patent application US 2013/0108744. as in patent GB 9323230. the pre-frying step has been replaced by cooking in a steam oven at 230-250° C. for 3 minutes in order to set the coating on the substrate.

In international patent application WO 2003/101228, the pre-frying step is also removed and the batter is coagulated in a hot water bath (70-80° C.) for 30 s before placing it in an oven or microwave oven. The final frying step (at the consumer's home) is however retained.

In patent CA 2114204, egg albumin is dried in order to stabilize the batter and form an adhesive film around the substrate.

In patent application US 20102/72871 and in the paper by Purcell et al. (Enzyme-modified starch as an oil delivery system for bake-only chicken nuggets, 2014, in Journal of Food Science, Vol 79, Nr. 5, 8), the use of a starch modified by enzymes to obtain a nugget having the sensory characteristics of a fried product is rather recommended.

Finally, document WO 2013/181524 proposes a process for coating an unfried food product intended to afford it the appearance, texture and flavor of fried products, this process comprising the application on the food product of an oil base followed by a composition based on starch, then water, and the cooking of the product obtained in this way.

However, none of these solutions is entirely satisfactory.

Moreover, this removal of the frying is not without consequence and therefore sets a significant technical challenge in obtaining the required organoleptic and visual qualities.

### SUMMARY OF THE INVENTION

The invention aims to develop a novel process for preparing nuggets, combining a step of modifying the properties of coating the nugget matrix with an alternative cooking process to traditional frying.

The present invention more particularly relates to a process for preparing nuggets, which comprises the successive steps consisting in:

1) covering a nugget matrix with wheat flour,
2) coating the flour-coated matrix with a batter consisting of:

a. 40 to 50% of a premix comprising:
i. rice flour,
ii. at least one polysaccharide that is hydrosoluble under cold conditions,
iii. at least one crosslinked pea starch, having an amylose content of between 30 and 40% (dry/dry),
iv. at least one dextrin

b. 40 to 55% of water.

c. 3% to 10% of fat(s),

the sum of the above percentages being equal to 100%,

3) pre-cooking the matrices coated in this way in a steam oven, in order to obtain nuggets, and
4) deep-freezing the nuggets obtained in this way.

It also relates to the nugget able to be obtained according to the above-described process.

### DETAILED DESCRIPTION OF THE INVENTION

Following an increasing demand from customers, the present invention especially targets a process for preparing nuggets, especially crispy chicken nuggets, that does not comprise a frying step.

The process for preparing unfried nuggets according to the invention comprises a first step consisting in coating a nugget matrix with flour using wheat flour. The nugget matrix usually includes meat and/or vegetables, water, flavorings, and optionally one or more binding agents. This step of coating in flour is followed by step of coating the flour-coated nuggets using a coating batter which is an emulsion comprising a premix, water and one or more fat(s).

Preferentially, the coating batter consists of 45% of a premix, 50% of water and 5% of fat.

The premix contains rice flour, at least one polysaccharide that is hydrosoluble under cold conditions, at least one cross-linked pea starch and at least one dextrin.

The rice flour is a key ingredient to give the nuggets obtained according to the invention a similar crispiness to that of commercial pre-fried nuggets. It has been observed that it does not increase the viscosity of the coating batter in an unacceptable manner, unlike wheat flour. The degree of incorporation thereof may be between 20 and 25%, preferably of the order of 24 to 25%, relative to the total weight of the premix.

The polysaccharide that is hydrosoluble under cold conditions, that is to say at a temperature of less than or equal to 25° C., may especially be chosen from:

chemically modified cellulose derivatives, such as hydroxyethyl cellulose (HEC), hydroxypropyl cellulose (HPC) or hydroxypropyl methyl cellulose (HPMC),

native or modified hemicelluloses,

pregelatinized starches and tuber or root starches, whether native or chemically modified,

plant-derived polysaccharides, such as pectins, guar gum, konjac gum, gum sterculia, locust bean gum or gum arabic,

algae-derived polysaccharides, such as agar, carrageenans, alginates and salts thereof,

microorganism-derived polysaccharides, such as xanthan gum or pullulan, and also mixtures thereof.

Use will preferably be made of a pregelatinized starch. In the present invention, the term “pregelatinized starch” is used to denote any native starch that has undergone a heat treatment in the presence of water, such that it entirely loses its granular structure and becomes soluble in cold water. The hydrothermal gelatinization treatment may be carried out by steam cooking, jet-cooker cooking, drum cooking, cooking in blender/extruder systems followed by drying, for example in an oven, by hot air on a fluidized bed, on a rotary drum, by atomization, by extrusion or by lyophilization.

The destructuring of the semi-crystalline granular state of the starch leads to amorphous pregelatinized starches with disappearance of the Maltese cross produced under polarized light. In the present invention, the pregelatinized starch preferably has a degree of crystallinity of less than 15%, preferably less than 5% and even more preferentially less than 1%, that is to say in an essentially amorphous state. This degree of crystallinity can in particular be measured by X-ray diffraction, as described in patent U.S. Pat. No. 5,362,777 (column 9, lines 8 to 24). Such starches generally have a solubility in demineralized water at 20° C. of greater than 5% and more generally of between 10 and 100%.

By way of example, mention may be made of the products manufactured and sold by the Applicant under the brand name Pregeflo. The polysaccharide, in particular the pregelatinized starch, may represent from 7 to 20%, preferably 15% of the total weight of the premix.

The premix used according to the invention also contains at least one cross-linked pea starch, having an amylose content of between 30 and 40%, preferably between 35 and 40%, these percentages being expressed as dry weight relative to the dry weight of starch contained in said composition. This is preferably a starch derived from smooth peas.

The crosslinking is carried out according to any technique known to those skilled in the art, so as to obtain a high degree of crosslinking. As crosslinking agent, use will preferably be made of sodium trimetaphosphate.

By way of indication, the limit will be a degree of crosslinking, expressed as fixed phosphorus, of 0.4% maximum. Such a product is especially sold by ROQUETTE under the trade name CLEARAMO L14000. This ingredient provides crispiness and uniformity of the coating batter. It may be incorporated in the premix at a content of between 35 and 40%, preferentially of the order of 37%, relative to the total weight of the premix.

Another ingredient of the premix according to the invention is a dextrin. Dextrin is intended to mean the products obtained by dry roasting of starch in the presence of acid. Although any type of dextrin may be suitable in the process according to the invention, pea dextrins are particularly preferred and in particular pea dextrins having an amylose content of between 30 and 40%, preferably between 35 and 40%. An example of such a dextrin is that sold by ROQUETTE FRERES under the trade name TACKIDEX® C760. The dextrin may represent from 10 to 20% of the total weight of the premix.

The premix may also comprise one or more (and preferably all) of the following ingredients:

at least one esterified starch salt,

wheat flour,

salt,

at least one acidic raising agent,

at least one bicarbonate.

The esterified starch salt is preferably a starch salt esterified by an alkenylsuccinic anhydride, in particular octenylsuccinic, which may for example be obtained as described in application EP 0 786 476. Preference is given to using a sodium octenyl succinate-modified starch prepared from waxy starch, of CLEARGUM® CO01 type, which serves as emulsifier and thus promotes the suspension and homogenization of the fats, and which also contributes to obtaining a nugget having an aerated visual appearance. It may be incorporated at an amount of 1 to 3% by weight, preferably 2% by weight relative to the total weight of the premix, for example.

The wheat flour is generally present in an amount ranging from 5 to 120% by weight relative to the total weight of rice flour.

The acidic raising agent is advantageously sodium pyrophosphate which generally represents from 0.1 to 1%/o by weight, preferably from 0.8 to 0.95% of the total weight of the premix.

The ingredients of the premix described above may be mixed by any means known to those skilled in the art. The premix is subsequently combined with water and with one or more fats, preferably chosen from vegetable oils, so as to form an emulsion corresponding to the coating batter, in the proportions stated above. The coating batter preferably consists of 45% of premix, 50% of water and 5% of fat.

This batter is subsequently applied to the flour-coated nugget matrices. The coated matrices are pre-cooked in a steam oven, preferably at 50% relative humidity and at a temperature of between 190 and 21° C., preferably from 200 to 210° C., for example of 204° C., for a duration of 5 to 10 minutes, preferably for 6 minutes. The deep-freezing step may subsequently be carried out, for example at a temperature of −30° C. for 20 to 40 minutes, preferably for 30 minutes.

Deep frozen nuggets are thus obtained which may be reheated in an oven, for example at a temperature of between 180 and 220° C., preferentially at 190° C., for a duration of 10 to 15 minutes, especially 13 minutes.

The nuggets obtained according to the invention have a reduced fat content, according to EC regulation 1924/2006, in the sense that they have a fat content of at most 7%. whereas the fat content of a similar (poultry-based) commercial nugget is of the order of 10% (including saturated lipids).

Moreover. the nuggets according to the invention have similar organoleptic characteristics to those of commercial nuggets, in terms of uniformity of coating, amount thereof (corresponding to the term “pick-up”) and thickness thereof, and also the appearance thereof, in particular the color thereof and the surface porosity thereof.

The invention will be understood more clearly with the aid of the following examples which are intended to be illustrative and nonlimiting.

### EXAMPLES

### Example 1: Preparation of a Nugget According to the Invention

A meat-based matrix was used to prepare the nuggets. It had the following composition:

| Ingredients | Amounts (g) |
|---|---|
| Meat | 720 |
| Ice-cold water | 147 |
| Pea fiber 150M | 20 |
| Salt | 10 |
| Pepper | 3 |
| Rehydration water | 80 |
| Pea proteins (NUTRALYS ® T65M) | 20 |
| Total | 1000 |

The pea fiber is used here as binding agent and for its degree of insolubility. NUTRALYS® also serves as binder. In the reconstitution of the nugget, this also makes it possible to substitute meat by supplying proteins.

The procedure for producing the nugget matrix is as follows:

| | |
|---|---|
| Phase 1: Mixer | Ground meat + ice; |
| | 1 min; max. speed |
| Phase 2: Mixer | Hydrated fibers + salt + pepper + NUTRALYS ® |
| | T65M; |
| | 2 min; max speed:, under vacuum |
| Phase 3: On plate | Formation of the matrix; meat spread on plate |
| Phase 4: Steam oven | Cooking at 50% humidity; |
| | 150° C; 4 min |
| Phase 5: Cutting | Cutting up the nuggets to 4 cm by 3 cm |

The nugget matrix was coated in flour using T55 wheat flour.

A premix having the following composition was subsequently prepared:

| Ingredients | Amount (g) |
|---|---|
| Rice flour | 24.25 |
| T55 wheat flour | 26.25 |
| Crosslinked pea starch (CLEARAM LI | 13.23 |
| 4000) | |
| Salt | 1 |
| Sodium pyrophosphate | 0.95 |
| Bicarbonate | 1.32 |
| Pregelatinized starch | 15 |
| Pea dextrin (TACKIDEX C760) | 15 |
| Esterified starch (CLEARGUM CO 01) | 2 |
| TOTAL | 100 g |

All the ingredients were weighed separately then mixed manually in order to homogenize everything and avoid lumps. The mixture was subsequently hydrated with water then emulsified with oil using a kitchen mixer, in the following proportions:

Premix: 45 g

Mineral water: 50 g

Sunflower oil: 5 g,

to obtain a coating batter which was applied to the flour-coated nugget matrices. The viscosity of the batter was sufficiently low to allow spreading thereof, while being high enough for it not to run in the oven.

The nuggets coated in this way were then precooked in a steam oven at 204° C. for 6 min, under 50% relative humidity, before being deep-frozen then cooked at 190° C. for 13 minutes.

While these nuggets had a reduced fat content, they had the same characteristics of appearance, especially of color and crispiness, as conventional commercial pre-fried nuggets.

In particular, the proportion by weight of coating (or “pick-up”) of these nuggets was evaluated. Said pick-up must be between 30% and 50% for a product to be deemed a nugget (Perera C. & Embuscado M. E. (2014), Texture design for breaded and battered foods. In: Lal Dar Y. & Light J. Food texture design and optimization. Chichester, UK. First edition. John Wiley & sons Ltd. P128-158). For measuring the pick-up, the substrates with flour coating were first weighed alone then weighed a second time with the coating batter. The percentage pick-up is calculated using the following formula:

Pick-up=[(weight of final product−weight of substrate with flour)/weight of final product]×100

The nuggets prepared as described above had a pick-up of 29.6%.

### Example 2: Influence of the Pre-Cooking Mode

Different methods for setting the coating of a nugget matrix coated in a similar manner to that described in example 1 were tested. These methods constituted alternatives to pre-frying, aiming to reduce the fat content of the nuggets, namely pre-cooking in a hot water bath and pre-cooking in an oven in which the relative humidity varied from 0% (conventional oven) to 100% (steam oven)

The tests carried out are presented in the following table.

| Steps | Material | Test 1 | Test 2 | Test 3 | Test 4 | Test 5 |
|---|---|---|---|---|---|---|
| Pre- | Water bath | [symbol] | [symbol] | 80° C.-30 s | [symbol] | [symbol] |
| cooking | Oven | 200° C. | [symbol] | [symbol] | 204° C. | 204° C. |
| | | 6 min | | | 6 min | 6 min |
| | | 0% RH | | | 50% RH | 100% RH |
| Deep | Deep | Yes | Yes | Yes | Yes | Yes |
| freezing | freezer | | | | | |
| Cooking | Oven | 190° C. | 190° C. | 190° C. | 190° C. | 190° C. |
| | | 13 min | 26 min | 13 min | 13 min | 13 min |
| Results | For the | Relatively | Relatively | Set | Relatively | Relatively |
| | batter | non- | non- | | non- | non-viscous |
| | | viscous | viscous | | viscous | |
| | For the | Non-crispy | Non-crispy | Uniform; | Uniform | More crispy |
| | nugget | | | Non-crispy | | |

RH = relative humidity

As can be seen from this table, pre-cooking in a steam oven gave the best results.

### Example 3: Optimizing the Visual Appearance

Nuggets were prepared as described in example 1, except that:

The content of Clearam® went from 12.4% to 37.08%,

The content of flour went from 26.25% to 2.4%, and

So as not to adversely affect the viscosity of the batter, the premix/water ratio was modified from 45:50 to 40:55.

It was observed that modifying the recipe from example 1 led to slightly less crispy nuggets but promoted the appearance of bubbles, thus recreating the structure obtained after frying (porous appearance associated with escaping bubbles of water). Visually, the nuggets thus more closely resembled traditional fried nuggets. In terms of flavor, the flavor of the flour was also less noticeable.

### Example 4: Influence of the Fat Content

With the aim of obtaining an appearance that comes close to a fried nugget, different fat contents were added to a premix similar to that of example 1.

### Ingredients and Proportions Tested:

5% fat: control

10% fat: Increase to observe whether or not there is an improvement in the visual aspect.

20% fat: Large increase in the amount of oil, more than possible in order to verify any added value in the operation.

The tests are presented in the following table.

| | Test 1 | Test 2 | Test 3 |
|---|---|---|---|
| Premix | 45 g | 45 g | 45 g |
| Mineral water | 50 g | 45 g | 35 g |
| Sunflower oil | 5 g | 10 g | 20 g |
| Results | | [symbol] No significant | [symbol] No significant |
| | | difference | difference for the |
| | | | nugget |
| | | | [symbol] Batter more |
| | | | difficult to emulsify |

No significant difference is observed between the different tests, such that the fat content may advantageously be limited to 5%, which makes it possible for the product to be categorized as a “light product”.

1. A process for preparing nuggets, which comprises the successive steps consisting in:
1) covering a nugget matrix with wheat flour,
2) coating the flour-coated matrix with a batter consisting of:
a. 40 to 50% of a premix comprising:
i. rice flour,
ii. at least one polysaccharide that is hydrosoluble under cold conditions,
iii. at least one crosslinked pea starch, having an amylose content of between 30 and 40% (dry/dry),
iv. at least one dextrin
b. 40 to 55% of water,
c. 3% to 10% of fat(s),
d. the sum of the above percentages being equal to 100%,
3) pre-cooking the matrices coated in this way in a steam oven, in order to obtain nuggets, and
4) deep-freezing the nuggets obtained in this way.

2. The process as claimed in claim 1, wherein the coating batter consists of 45% of premix, 50% of water and 5% of fat.

3. The process as claimed in claim 1, wherein the polysaccharide is a pre-gelatinized starch.

4. The process as claimed in claim 1, wherein the content of rice flour is between 20 and 25%, preferably of the order of 24 to 25%, relative to the total weight of the premix.

5. The process as claimed in claim 1, wherein the polysaccharide represents from 7 to 20% of the total weight of the premix.

6. The process as claimed in claim 1, wherein the content of crosslinked starch is between 35 and 40% relative to the total weight of the premix.

7. The process as claimed in claim 1, wherein the dextrin represents from 10 to 20% of the total weight of the premix.

8. The process as claimed in claim 1, wherein the premix comprises one or more of the following ingredients:
at least one esterified starch salt,
wheat flour,
salt,
at least one acidic raising agent,
at least one bicarbonate.

9. The process as claimed in claim 1, wherein the deep-freezing step is carried out at a temperature of −30° C. for 20 to 40 minutes.

10. The process as claimed in claim 1, wherein the pre-cooking step is carried out at a relative humidity of 50% and at a temperature of between 190 and 210° C.

11. A nugget obtained according to the process defined in claim 1.
